(19) United States
(12) Patent Application Publication
(10) Pub. No.: US 2008/0157668 A1
(43) Pub. Date: Jul. 3, 2008

(54) Plasma display panel and method of manufacturing the same

(75) Inventors: Dongki Paik, Yongin-si (KR); Kwang Yeol Choi, Seongnam (KR); Jongrae Lim, Anyang-si (KR); Wootae Kim, Yongin-si (KR); Sung Chun Choi, Anyang-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/647,412

(22) Filed: Dec. 29, 2006

(51) Int. Cl. H01J 17/49; H01J 9/02

(52) U.S. Cl. 313/584; 445/24

(57) ABSTRACT

Disclosed are a plasma display panel and a method of manufacturing the same. The plasma display panel includes a scan electrode and a sustain electrode formed on a glass substrate, each including a discharge ignition part for generating initial discharge and a discharge diffusion portion for diffusing discharge to the entirety using the initial discharge, and the plasma display panel includes a dielectric layer disposed on a upper side of the glass substrate to cover the scan electrode and sustain electrode.

### BACKGROUND

1. Field

This document relates to a plasma display panel and a method of manufacturing the same.

2. Description of the Background Art

In a general plasma display panel, barrier ribs formed between a front panel and a real panel constitute unit cells, each of which is filled with a main discharge gas such as Ne, He, or a mixture of Ne and He and small amount of inert gases containing Xe. A discharge induced by a high frequency voltage causes the inert gases to generate vacuum ultraviolet rays, and these vacuum ultraviolet rays excite phosphors provided between barrier ribs to display images. Because this plasma display panel can be made thinner and lighter, it has been popular as a next generation display.

FIG. 1 is a view illustrating a structure of a general plasma display panel.

Referring to FIG. 1, the plasma display panel comprises a front panel 100 and a rear panel 110, which are spaced in parallel with each other by a constant distance. The front panel 100 comprises a front glass 101 on which a plurality of sustain electrode pairs, each of which is paired by a scan electrode 102 and a sustain electrode 103, are arranged. The rear panel 110 comprises a rear glass 111 on which a plurality of address electrodes are arranged to intersect the sustain electrode pairs.

The front panel 100 comprises pairs of a scan electrode 102 and a sustain electrode 103 to cause a discharge at a discharge cell and maintain the emission of cell, the scan electrode 102 or sustain electrode 103 consisting of a transparent electrode (a) made of a transparent material, and a bus electrode (b) made of a metallic material. The scan electrode 102 and sustain electrode 103, which restrict discharge current, are covered by an upper dielectric layer 104 serving to isolate between electrode pairs, and a protective layer 105 deposited with MgO is disposed on the upper surface of the upper dielectric layer 104 in order to mitigate discharge conditions.

The rear panel 110 comprises the address electrodes 113 arranged on the rear glass 111 in the direction of intersecting the scan electrodes 102 and sustain electrodes 103 arranged in parallel on the front glass 101, and a lower dielectric layer 115 is disposed on the upper side of the address electrodes 113. Barrier ribs 112 are provided on the upper side of the lower dielectric layer 115 to define discharge cells, each of which is applied with a phosphor 114 to radiate visual light having any one of red, green, and blue colors upon discharge. Manufacturing processes of a front panel according to the prior art will now be described with reference to FIG. 2.

FIG. 2 is a flow chart illustrating sequential processes for manufacturing a front panel of a plasma display panel according to the prior art.

Referring to FIG. 2, a transparent electrode 201 made of ITO (Indium Tin Oxide) which consists of Indium oxide and Tin oxide is disposed on the upper side of a front glass 200 (Step (a)).

As an example, the transparent electrode 201, which consists of a transparent electrode 201a for scan and a transparent electrode 201b for sustain, is formed by laminating dry film photoresist on a transparent electrode film made of ITO, exposing it to light to have a predetermined pattern with a photo mask, and developing and etching it.

Then, black paste is printed on the upper side of the front glass 200 formed with the transparent electrode 201a for scan and transparent electrode 201b for sustain and is dried at approximately 120□ to form a black layer (Step (b)), and ultraviolet rays are illuminated on the dried black paste, with a photo mask 205 having a given pattern placed on the black paste (Step (c)). These processes are called “photolithography”.

After the photolithography process, on the upper side of the black layer 202 is applied Ag paste, printed and dried to form bus the electrodes 203a, 303b (Step (d)).

Afterwards, the photo mask 206 with a given pattern is placed on the upper side of the applied Ag paste, and exposed to light (Step (e)). After the exposure process, part which has been not cured is developed and fired in a baking furnace (not shown) at a temperature above 550□ for about 3 hours, forming the bus electrode 203a for scan and bus electrode 203b for sustain (Step (f)).

Then, an upper dielectric layer 207 is formed on the upper side of the front glass 200 formed with the scan electrodes 201a, 203a and sustain electrodes 201b, 203b (Step (g)). As an example of a method for forming the dielectric layer 207, dielectric glass paste is applied and dried, and then fired at a temperature approximately between 500□ and 600□, forming the upper dielectric layer.

Finally, a protective layer 208 made of MgO is formed on the surface of the upper dielectric layer 207 using a CVD method, ion plating method, vapor deposition method, and so forth (Step (h)), completing a front panel of a plasma display panel.

However, the plasma display panel and method of manufacturing the same according of the prior art have required high cost transparent electrodes, having caused manufacturing costs to increase dramatically. A fence type electrode structure, which does not use transparent electrodes, has been proposed to overcome this problem.

FIG. 3 is a plan view illustrating a discharge cell having a fence type electrode structure according to the prior art. Referring to FIG. 3, a discharge cell 310 having a fence type electrode structure comprises a front substrate (not shown) formed with an upper discharge diffusion part 320 and a lower discharge diffusion part 340 and a rear substrate (not shown) formed with barrier ribs to define discharge cells 310, wherein on the upper discharge diffusion part 320 and the lower discharge diffusion part 340 are not provided high cost transparent electrodes but metallic electrodes only.

At this time, each of the upper discharge diffusion part 320 and lower discharge diffusion part 340 comprises three main discharge parts 320a, 340a and two connection discharge parts 320b, 340b to form a discharge gap 350 between the upper discharge diffusion part 320 and lower discharge diffusion part 340 and connect the discharge gap 350 to the connection discharge parts 320b, 340b to thereby diffuse discharge. In other words, the upper discharge diffusion part 320 and lower discharge diffusion part 340 are provided to compensate for loss of effective area which can occur due to absence of transparent electrodes.

In this fence type electrode structure, however, an opaque upper discharge diffusion part and an opaque lower discharge diffusion part occupy a large area in the discharge space, which causes a problem that aperture ratio decreases upon discharge. Furthermore, this fence type electrode structure has a smaller effective area than a conventional electrode structure having transparent electrodes, which acts as a limitation to effective discharge diffusion.

Accordingly, brightness is down and voltage for starting discharge upon driving is up, causing discharge efficiency to decrease. And, a gab (d) between the upper discharge diffusion part and lower discharge diffusion part in the discharge cell is too small to make it impossible to use other portions than negative glow portions in a discharge area upon driving. The afore-mentioned discharge space is shown in FIG. 3.

FIG. 4 is a view illustrating a discharge region between electrodes.

Referring to FIG. 4, if voltage is applied between a cathode and an anode, then secondary electrons, which are generated and released by ion-to-cathode collision, are accelerated by electric fields and crashed with neutral particles, so that new electrons are generated. As the voltage is varied more frequently, the secondary electrons are more strongly accelerated at the negative glow portions having relatively strong electric fields. The electrons generated by collision are continuously energized while ionization proceeds, and reach positive column portions, where the electrons are not energized any more and transfer energy to the neutral particles by collision. In this course, excited particles fall down to the bottom state, so that visible light and vacuum ultraviolet rays are radiated.

At the positive column portions in the discharge region, only electrons whose overall energy is high rather than electrons whose energy is from electric fields excite gases to emit light. At the positive column portions, in addition, ionization rarely occurs and the amount of light emission by excitation increases, so that conversion efficiency from energy to light is generally high.

Hence, if the gap between the upper discharge diffusion part and lower discharge diffusion part decreases at the discharge cell in the plasma display panel, then area of negative glow portions is not so varied while area of positive column portions is relatively greatly decreased. Therefore, there occurs a problem that emission brightness of the plasma display panel is deteriorated.

### SUMMARY

In one aspect, a plasma display panel comprises a scan electrode and a sustain electrode formed on a glass substrate, each comprising a discharge ignition part for generating initial discharge and a discharge diffusion portion for diffusing discharge to the entirety using the initial discharge, and a dielectric layer disposed on a upper side of the glass substrate to cover the scan electrode and sustain electrode.

The scan electrode may be symmetrical to the sustain electrode.

The scan electrode and the sustain electrode each may have a shape of ‘H’.

The scan electrode and the sustain electrode each may have a shape of ‘U’.

The scan electrode and the sustain electrode may be formed only of metallic electrodes.

The discharge ignition part may comprise an upper discharge ignition part and a discharge ignition part, and the upper discharge ignition part and the lower discharge ignition part may be located on a upper side of barrier ribs.

The discharge ignition part may comprise an upper discharge ignition part and a discharge ignition part, and a gap between the upper discharge ignition part and the lower discharge ignition part may range from 50 μm to 150 μm.

The a discharge diffusion portion may comprise an upper discharge ignition part and a lower discharge ignition part, and a gap between the upper discharge diffusion part and the lower discharge diffusion part may range from 150 μm to 500 μm.

A line width of each of the metallic electrodes may range from 20 μm to 70 μm.

The dielectric layer may have uneven thickness so that a first part where initial discharge occurs has thinner thickness than a second part other than the first part.

The dielectric layer may be formed to have a shape of a groove.

An auxiliary dielectric layer may be provided on a upper side of the dielectric layer, and the auxiliary dielectric may has a higher dielectric constant than that of the dielectric layer.

In another aspect, a method of manufacturing a plasma display panel comprises forming a scan electrode and a sustain electrode on a front glass substrate; forming a dielectric layer to cover the scan electrode and the sustain electrode, and forming a groove on the dielectric layer.

The method may comprise forming an auxiliary dielectric layer in the groove posterior to said forming the groove.

The groove may be formed on a portion where initial discharge occurs.

### BRIEF DESCRIPTION OF THE DRAWING

Further detailed description of the other embodiments will be contained in the accompanying detailed description and drawings. The above and/or other aspects and advantages of the prevent invention will become apparent and more readily appreciated from the following description of the exemplary embodiments, taken in conjunction with the accompany drawings, where like reference numerals refer to like elements throughout, in which:

FIG. 1 is a view illustrating a structure of a general plasma display panel;

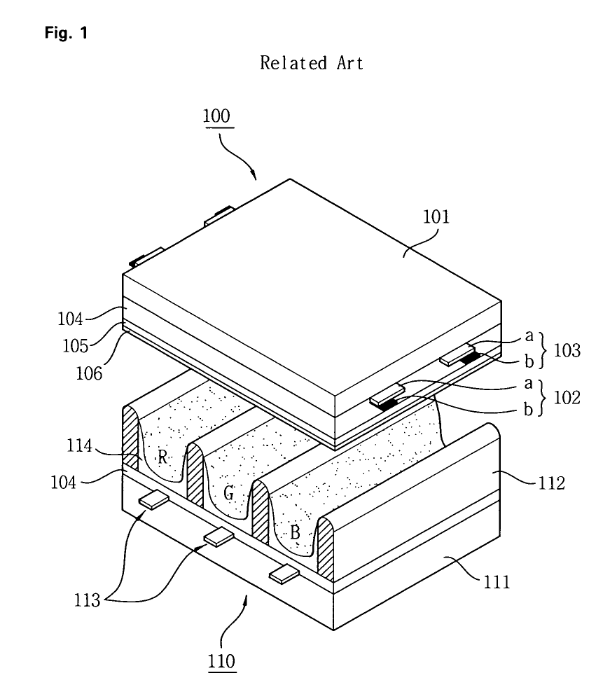

FIG. 2 is a process flow view illustrating sequential processes for manufacturing a front panel of a plasma display panel according to the prior art;

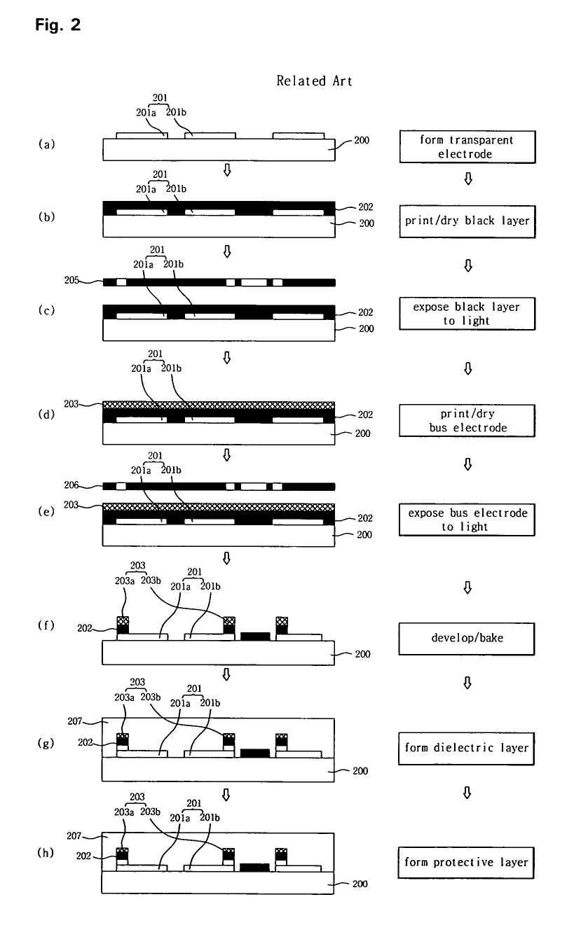

FIG. 3 is a plan view illustrating a discharge cell having a fence type electrode structure according to the prior art;

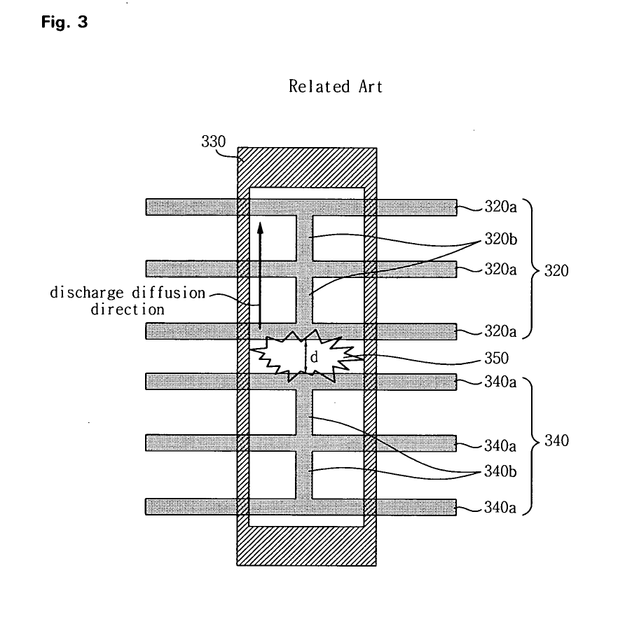

FIG. 4 is a view illustrating a discharge region between electrodes according to the prior art;

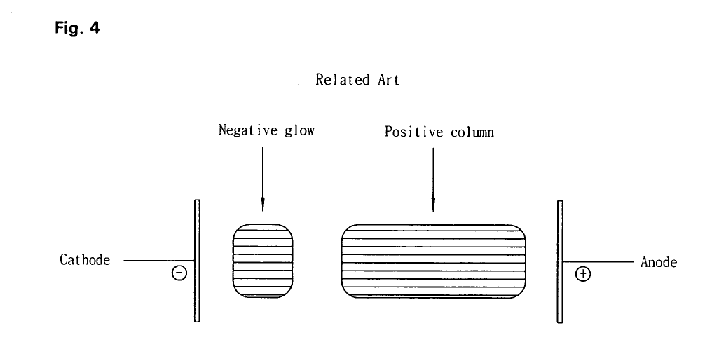

FIG. 5 is a plan view illustrating a discharge cell having a fence type electrode structure according to an embodiment of the present invention;

FIG. 6 is a plan view illustrating a discharge cell having another fence type electrode structure according to another embodiment of the present invention;

FIG. 7 is a view illustrating a dielectric layer having uneven thickness distribution in a plasma display panel according to an embodiment of the present invention;

FIG. 8 is a view illustrating a dielectric layer having uneven thickness distribution in a plasma display panel according to an embodiment of the present invention;

FIG. 9 is a process flow view illustrating sequential processes for manufacturing a front panel of a plasma display panel according to an embodiment of the present invention; and

FIG. 10 is a process flow view illustrating sequential processes for manufacturing a front panel of another plasma display panel according to another embodiment of the present invention.

### DETAILED DESCRIPTION OF EMBODIMENTS

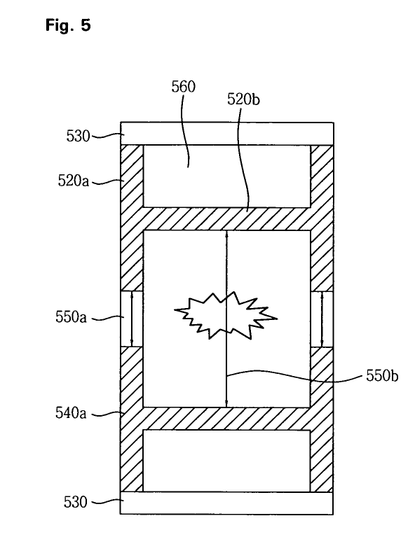

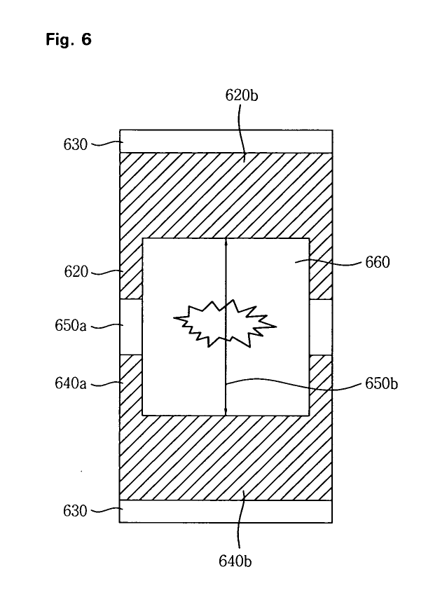

A plasma display panel according to an embodiment of the present invention will be described with reference to FIGS. 5 to 8. FIG. 5 is a plan view illustrating a discharge cell having a fence type electrode structure according to an embodiment of the present invention. FIG. 6 is a plan view illustrating a discharge cell having another fence type electrode structure according to another embodiment of the present invention.

Referring to FIGS. 5 and 6, a plasma display panel according to an embodiment of the present invention comprises a front glass substrate (not shown) formed with scan electrodes 520, 620 and sustain electrodes 540, 640 and a rear glass substrate (not shown) formed with address electrodes (not shown) in the direction of intersecting the scan electrodes 520, 620 and sustain electrodes 540, 640. And, barrier ribs 530, 630 are formed on the rear glass substrate to define discharge cells 560, 660, so that positive column portions can be used when discharge occurs.

At this time, the scan electrodes 520, 620 and the sustain electrodes 540, 640 are symmetrical to each other. It is desirable that the scan electrodes 520, 620 and the sustain electrodes 540, 640 are formed to have a shape of ‘H’ (see FIG. 5) or ‘U’ (see FIG. 6).

Forming the scan electrodes 520, 620 and sustain electrodes 540, 640 in the shape of ‘H’ or ‘U’ enables wall charges to accumulate sufficiently while securing aperture ratio as much as possible.

At this time, it is desirable that the scan electrodes 520, 620 and sustain electrodes 540, 640 are composed only of metallic electrodes. Although the metallic electrode generally has narrower width than that of the transparent electrode in a discharge space, the metallic electrode can replace the transparent electrode, which is relatively more expensive than the metallic electrode, by modifying the design, and this can reduce dramatically costs for manufacturing scan electrodes and sustain electrodes.

The metallic electrodes 520, 540, 620, 640 comprise upper discharge ignition portions 520a, 620a and lower discharge ignition portions 540a, 640a, which are located along the barrier ribs 530, 630 defining discharge cells 560, 660 to cause initial discharge, and upper discharge diffusion portions 520b, 620b and lower discharge diffusion portions 540b, 640b, which radiate light at a positive column portion in the discharge cells 560, 660 using the initial discharge and diffuse light to the entire discharge cell regions 560, 660.

At this time, it is desirable that the metallic electrodes 520, 540, 620, 640 each have a line width of more than 20 μm and less than 70 μm.

And, it is desirable that a gap between the upper discharge ignition portion 520a, 620a and the lower discharge ignition portion 540a, 640a ranges from 50 μm to 150 μm.

In addition, it is desirable that a gap between the upper discharge diffusion portion 520b, 620b and the lower discharge diffusion portion 540b, 640b ranges from 150 μm to 500 μm

Here, the upper discharge ignition portions 520a, 620a and lower discharge ignition portions 540a, 640a are placed at the upper part than the barrier ribs because the discharge ignition portions 520a, 620a, 540a, 640a cause only weak discharge which can't generate plasma, so that aperture ratio can be deteriorated.

The discharge ignition portions 520a, 620a, 540a, 640a can easily cause discharge even with low discharge voltage because of short discharge gap 550a, 650a. At this time, since once discharge starts it diffuses to the discharge diffusion portions 520b, 620b, 540b, 640b, even low discharge voltage can generate discharge well.

Accordingly, providing the discharge ignition portions 520a, 620a, 540a, 640a enables high efficiency even with relatively low discharge start voltage.

In general, a plasma display panel has the same structure as a capacitor. Therefore, as the distance between electrodes increases more, capacitance becomes smaller, and this lowers reactive power, thus improving discharge efficiency.

As such, making the discharge gaps 550b, 650b long enables allows for high discharge efficiency.

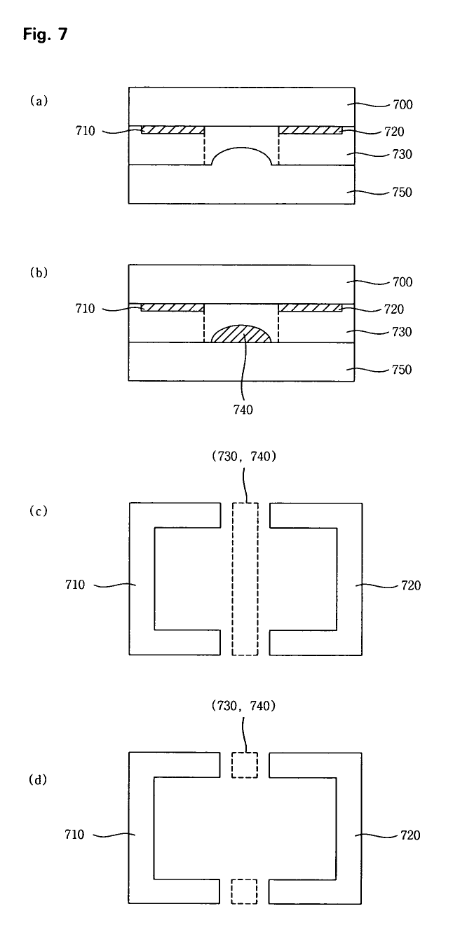

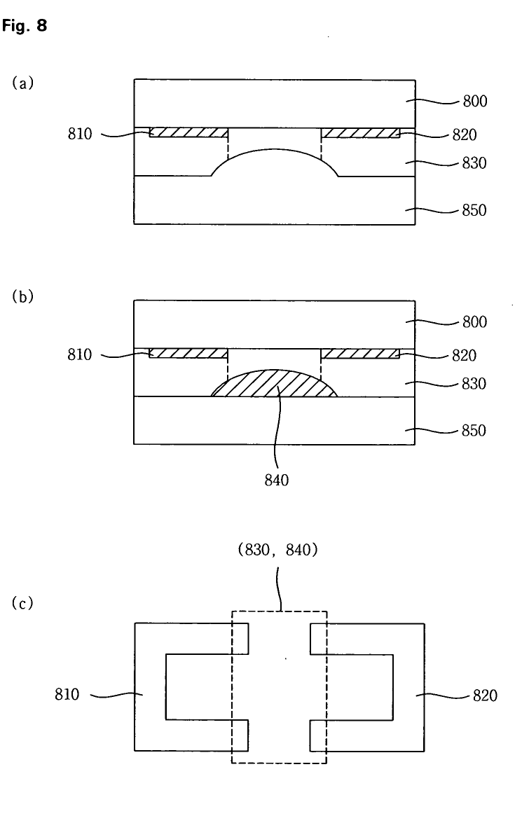

A dielectric layer having uneven thickness distribution is shown in FIGS. 7 and 8, which can reduce the discharge voltage of the plasma display panel and improve the discharge efficiency of the plasma display panel.

FIG. 7 is a schematic view illustrating a dielectric layer having uneven thickness distribution in a plasma display panel according to an embodiment of the present invention. FIG. 8 is a schematic view illustrating a dielectric layer having uneven thickness distribution in a plasma display panel according to an embodiment of the present invention.

Referring to FIG. 7, the dielectric layer 730, which has uneven thickness distribution, restricts the discharge current between a scan electrode 710 and a sustain electrode 720 and isolates therebetween. In addition, a protective layer 750 deposited with MgO is provided on the upper surface of the dielectric layer 730 to mitigate discharge conditions.

At this time, the dielectric layer 730 is uneven in its thickness distribution, and is formed to have a depression part depressed by a predetermined depth at the center of the discharge cell. Here, it is desirable that the depression part is located between metallic electrodes (see FIG. 7c). In addition, it is also desirable that the depression part is located only on the discharge ignition portions among the discharge electrodes (see FIG. 7d).

It is desirable that the dielectric layer 730 is formed to have a shape of a groove. The groove comprises a ‘U’ shape, a trapezoid shape, a semicircle shape, and so forth.

In addition, it is desirable that on the upper side of the dielectric layer 730 there is further provided another dielectric layer 740 having relatively a higher dielectric constant than that of the dielectric layer 730 (see FIG. 7b).

It is desirable that the depression part is located to cover part of ends of the metallic electrodes between the metallic electrodes (see FIG. 8c).

It is desirable that the dielectric layer 830 is formed to have a shape of a groove. The groove comprises a ‘U’ shape, a trapezoid shape, a semicircle shape, and so forth.

In addition, it is desirable that on the upper side of the dielectric layer 830 there is further provided another dielectric layer 840 having relatively a higher dielectric constant than that of the dielectric layer 830 (see FIG. 8b).

These dielectric layers 730, 830 and the auxiliary dielectric layers 740, 840 increase the electric fields generated when the plasma display panel is driven, so that even more wall charges can be accumulated, which can reduce driving voltage upon plasma surface discharge, thus making it possible to improve the discharge efficiency.

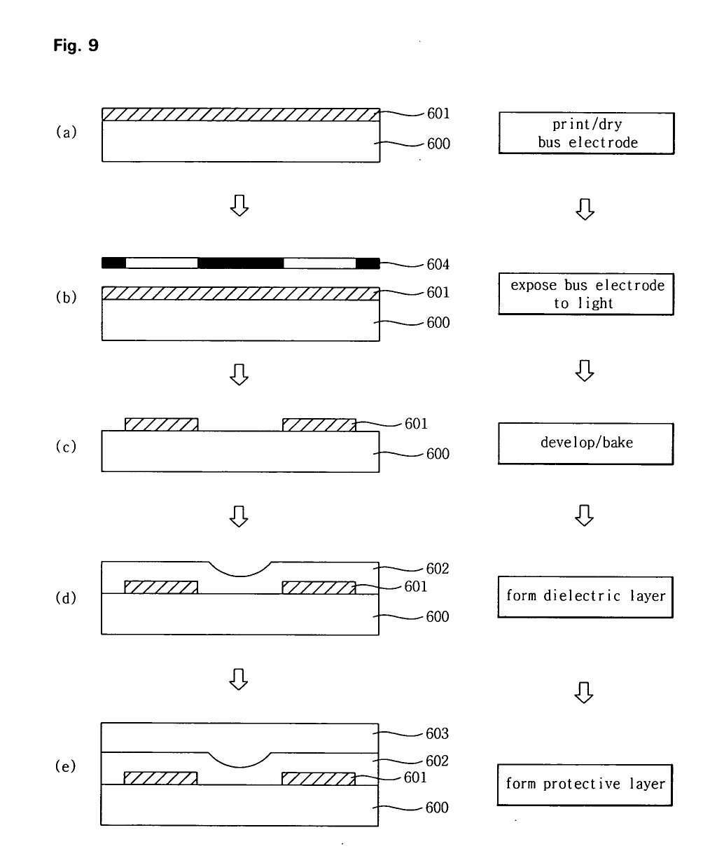

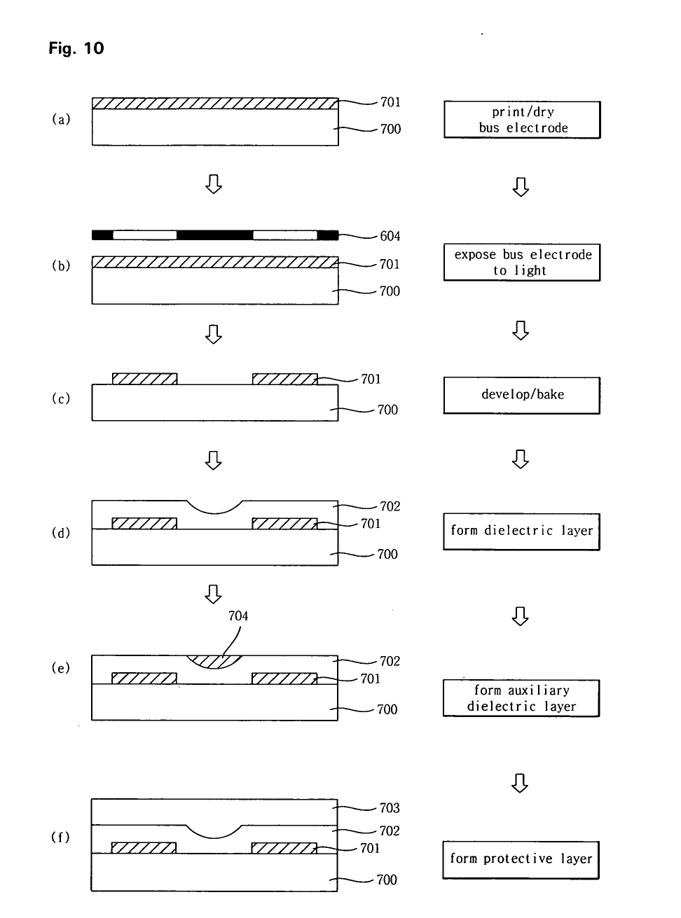

Processes of manufacturing a front panel in a plasma display panel according to an embodiment of the present invention will be described with reference to FIGS. 9 and 10. FIG. 9 is a process flow view illustrating sequential processes for manufacturing a front panel of a plasma display panel according to an embodiment of the present invention. FIG. 10 is a process flow view illustrating sequential processes for manufacturing a front panel of another plasma display panel according to another embodiment of the present invention.

Referring to FIG. 9, Ag paste is applied on the upper side of a front glass 600, printed, and dried so as to form metallic electrodes 601 on the front glass 600 (Step (a)). Then, a photo mask 604 formed with a predetermined pattern is placed on the upper side of the Ag paste, and exposed to light (Step (b)). Next, part not cured is developed and then fired in a baking furnace (not shown) at a temperature over 550□ for about 3 hours, completing metallic layers 601 (Step (c)).

Then, a dielectric layer 602 is formed to cover the metallic electrodes 601 and the front glass 600 (Step (d)). At this time, the dielectric layer 602 is formed to have uneven thickness distribution, so that the thickness at the gap between the metallic electrodes 601 is different from the thickness at the part other than the gap.

As an example for forming the dielectric layer 602, firstly a dielectric layer is provided on the front glass 600 to have a predetermined thickness, and secondly the dielectric layer is etched at a given depth using as a mask a photosensitive film patterned to have a predetermined pattern, so that a groove is formed to have a discharge space.

Finally, a protective layer 603 made of MgO is formed on the surface of the dielectric layer 602 using a CVD method, ion plating method or vapor deposition method, completing a front panel of a plasma display panel.

At this time, it is desirable that the groove of the dielectric layer 602 is formed at the portion where initial discharge occurs.

In addition, it is desirable that an auxiliary dielectric layer 704 having a given pattern is formed on the upper side of the dielectric layer 702 after Step (d) in FIG. 9, as shown in FIG. 10.

At this time, it is desirable that the groove of the dielectric layer 702 is formed at the portion where initial discharge occurs.

It is to be understood by those skilled in the art that the invention may be embodied in several forms without departing from the spirit of essential characteristics thereof. The scope of the present invention is defined by the appended claims rather than by the description preceding them, and all changes that fall within meets and bounds of the claims, or equivalence of such meets and bounds are therefore intended to embrace by the claims.

As mentioned above, the present invention forms scan electrodes and sustain electrodes only with metallic electrodes without forming transparent electrodes, so that manufacturing costs for the scan electrodes and sustain electrodes can be saved, and the present invention can assure high efficiency or reduce discharge voltage by selecting either a long discharge gap or a short discharge gap. In addition, the present invention can reduce driving voltage upon plasma surface discharge by providing a dielectric layer having uneven thickness distribution and an auxiliary dielectric layer, thus making it possible to improve the discharge efficiency.

What is claimed is:

1. A plasma display panel comprising:
a scan electrode and a sustain electrode formed on a glass substrate, each comprising a discharge ignition part for generating initial discharge and a discharge diffusion portion for diffusing discharge to the entirety using the initial discharge; and
a dielectric layer disposed on a upper side of the glass substrate to cover the scan electrode and sustain electrode.

2. The plasma display panel of claim 1, wherein the scan electrode is symmetrical to the sustain electrode.

3. The plasma display panel of claim 1, wherein the scan electrode and the sustain electrode each have a shape of ‘H’.

4. The plasma display panel of claim 1, wherein the scan electrode and the sustain electrode each have a shape of ‘U’.

5. The plasma display panel of claim 1, wherein the scan electrode and the sustain electrode each comprise a metallic electrode.

6. The plasma display panel of claim 1, wherein the discharge ignition part comprises an upper discharge ignition part and a discharge ignition part, and
the upper discharge ignition part and the lower discharge ignition part are located on a upper side of barrier ribs.

7. The plasma display panel of claim 1, wherein the discharge ignition part comprises an upper discharge ignition part and a lower discharge ignition part, and
a gap between the upper discharge ignition part and the lower discharge ignition part ranges from 50 μm to 150 μm.

8. The plasma display panel of claim 1, wherein the a discharge diffusion portion comprises an upper discharge ignition part and a lower discharge ignition part, and
a gap between the upper discharge diffusion part and the lower discharge diffusion part ranges from 150 μm to 500 μm.

9. The plasma display panel of claim 5, wherein a line width of the metallic electrode ranges from 20 μm to 70 μm.

10. The plasma display panel of claim 5, wherein the dielectric layer has uneven thickness so that a first part where initial discharge occurs has thinner thickness than a second part other than the first part.

11. The plasma display panel of claim 10, wherein the dielectric layer is formed to have a shape of a groove.

12. The plasma display panel of claim 10, wherein an auxiliary dielectric layer is provided on a upper side of the dielectric layer, and the auxiliary dielectric layer has a higher dielectric constant than that of the dielectric layer.

13. A method of manufacturing a plasma display panel comprising:
forming a scan electrode and a sustain electrode on a front glass substrate;
forming a dielectric layer to cover the scan electrode and the sustain electrode; and
forming a groove on the dielectric layer.

14. The method of claim 13, further comprising forming an auxiliary dielectric layer in the groove posterior to said forming the groove.

15. The method of claim 13, wherein the groove is formed on a portion where initial discharge occurs.
